(19) United States
(12) Patent Application Publication
(10) Pub. No.: US 2026/0100030 A1
(43) Pub. Date: Apr. 9, 2026

(54) ELECTRONIC APPARATUS AND CONTROL METHOD THEREOF

(71) Applicant: SAMSUNG ELECTRONICS CO., LTD., Suwon-si (KR)

(72) Inventor: Byunghee PARK, Suwon-si (KR)

(73) Assignee: SAMSUNG ELECTRONICS CO., LTD., Suwon-si (KR)

(21) Appl. No.: 19/415,088

(22) Filed: Dec. 10, 2025

Related U.S. Application Data
(63) Continuation of application No. PCT/KR2025/013722, filed on Sep. 4, 2025.

(30) Foreign Application Priority Data
Sep. 4, 2024 (KR) 10-2024-0120283

(51) Int. Cl. G06V 10/82; G06F 3/048; G06F 3/14; G06V 10/75; G06V 10/764

(52) U.S. Cl. CPC G06V 10/82; G06F 3/048; G06F 3/1407; G06V 10/758; G06V 10/764

(57) ABSTRACT

Provided is an electronic apparatus including memory configured to store at least one instruction, and a processor configured to execute the at least one instruction to obtain a first image including an object, input the first image to a first neural network model that is configured to be trained by using a plurality of second images in relation to a plurality of predefined types, obtain first probability information including a first probability of the object corresponding to a first type among the plurality of types and a second probability of the object corresponding to a second type among the plurality of types, obtain second probability information, through a second neural network model, indicating a type of the object included in the first image, by using a plurality of third images corresponding to the first type and a plurality of fourth images corresponding to the second type based on a difference between the first probability and the second probability being less than a first threshold value and based on a first input, and identify the type of the object based on the second probability information.

### CROSS-REFERENCE TO RELATED APPLICATIONS

This application is a bypass continuation of International Application No. PCT/KR2025/013722, filed on Sep. 4, 2025, which is based on and claims priority to Korean Patent Application No. 10-2024-0120283, filed on Sep. 4, 2024, in the Korean Intellectual Property Office, the disclosures of which are incorporated by reference herein in their entireties.

### BACKGROUND

Embodiments of the present disclosure relate to an electronic apparatus and a control method thereof, and particularly to, an electronic apparatus capable of identifying a type of an object included in an image and a control method thereof.

In recent years, advancements in technologies for identifying an object included in an image more accurately and efficiently by using a neural network model have accelerated. In particular, in the case of a neural network model implemented in an on-device form, the neural network model may be trained in a server by using large amounts of learning data and then provided to an electronic apparatus of the user, and may identify an object of an image obtained by the electronic apparatus even without using the server.

However, in the case where a distribution of data used for learning and a distribution of data input are different after the neural network model is provided to the electronic apparatus, accuracy of the neural network model may deteriorate and problems such as dataset drift may occur.

In this case, additional learning needs to be performed by using data having a new distribution to update the neural network model, but it is difficult to perform the additional learning with a resource of the electronic apparatus, and performing the additional learning again by the server and distributing the neural network model again to the electronic apparatus may consume significant resources and time. In addition, in the case where the data having a new distribution are collected by the electronic apparatus, there is a limitation of the collection of the data for reasons of the protection of personal information and the like.

### SUMMARY

To overcome the above-described limitations, the present disclosure is directed to providing an electronic apparatus capable of performing an object identification of an image having a new distribution accurately without additional learning of a neural network model, despite a difference between a distribution of data used for learning and a distribution of data input actually, and a control method thereof.

According to an aspect of one or more embodiments, there is provided an electronic apparatus including memory configured to store at least one instruction, and a processor configured to execute the at least one instruction to obtain a first image including an object, input the first image to a first neural network model that is configured to be trained by using a plurality of second images in relation to a plurality of predefined types, obtain first probability information including a first probability of the object corresponding a first type among the plurality of types and a second probability of the object corresponding to a second type among the plurality of types, obtain second probability information, through a second neural network model, indicating a type of the object included in the first image, by using a plurality of third images corresponding to the first type and a plurality of fourth images corresponding to the second type based on a difference between the first probability and the second probability being less than a first threshold value and based on a first input, and identify the type of the object based on the second probability information.

The second neural network model may be configured to be trained based on a plurality of fifth images different from the plurality of second images, and obtain the second probability information based on a first similarity between the first image and the plurality of third images and a second similarity between the first image and the plurality of fourth images.

The electronic apparatus may further include a display, wherein the first type may be a type that is identified through the first neural network model as a type among the plurality of types corresponding to the highest first probability, wherein the second type may be a type that is identified through the first neural network model as a type among the plurality of types corresponding to the second highest first probability, and wherein the processor may be further configured to identify the first type as the type of the object based on a difference between the first probability and the second probability being equal to or greater than the first threshold value and the first probability being equal to or greater than a preset second threshold value.

The processor may be further configured to control the display to display a user interface including information on the first type and information on the second type based on the difference between the first probability and the second probability being equal to or greater than the first threshold value and the first probability being less than the second threshold value, receive a second user input selecting the type of the object through the user interface, identify the first type as the type of the object based on the second user input corresponding to the first type, obtain the second probability information through the second neural network model based on the second user input corresponding to the second type, and identify the type of the object based on the second probability information.

The second probability information may include a third probability of the object corresponding to the first type and a fourth probability of the object corresponding to the second type, and wherein the processor may be further configured to identify the first type as the type of the object based on the third probability being greater than the fourth probability.

The processor may be further configured to control the display to display the user interface based on the third probability being less than the fourth probability, receive a third user input, through the user interface, selecting the type of the object, and identify the type of the object based on the third user input.

The user interface may include a first item corresponding to the first type, and a second item corresponding to the second type, and wherein the processor may be further configured to determine at least one of a size of the first item, a transparency of the first item, a size of the second item, and a transparency of the second item based on a size of the third probability and a size of the fourth probability.

The memory may be further configured to store the plurality of third images and the plurality of fourth images, and the processor may be further configured to update the plurality of third images stored in the memory based on the first image based on the third user input corresponding to the first type.

The memory may be further configured to store information on fifth probabilities of each of the plurality of third images corresponding to the first type, and the processor may be further configured to update the plurality of third images stored in the memory by replacing a third image corresponding to the one probability with the first image and storing the first image in the memory based on the third probability being greater than one of the fifth probabilities.

The processor may be further configured to increase the first threshold value by a preset value based on the first probability being greater than the second probability, the third probability being less than the fourth probability, and the third user input corresponding to the second type.

According to an aspect of one or more embodiments, there is provided a control method of an electronic apparatus, the method including obtaining a first image including an object, inputting the first image to a first neural network model that is configured to be trained by using a plurality of second images in relation to a plurality of predefined types, obtaining first probability information including a first probability of the object corresponding a first type among the plurality of types and a second probability of the object corresponding to a second type among the plurality of types, obtaining second probability information, through a second neural network model, indicating a type of the object included in the first image, by using a plurality of third images identified as corresponding to the first type and a plurality of fourth images identified as corresponding to the second type, based on a difference between the first probability and the second probability being less than a first threshold value and based on a first user input, and identifying the type of the object based on the second probability information.

The second neural network model may be configured to be trained based on a plurality of fifth images different from the plurality of second images, and obtain the second probability information based on a first similarity between the first image and the plurality of third images and a second similarity between the first image and the plurality of fourth images.

The first type may be a type that is identified through the first neural network model as a type among the plurality of types corresponding to the highest first probability, wherein the second type may be a type that is identified through the first neural network model as a type among the plurality of types corresponding to the second highest first probability, and wherein the method may further include identifying the first type as the type of the object based on the difference between the first probability and the second probability being equal to or greater than the first threshold value and the first probability being equal to or greater than a second threshold value.

The method may further include displaying a user interface comprising information on the first type and information on the second type based on the difference between the first probability and the second probability being equal to or greater than the first threshold value and the first probability being less than the second threshold value, receiving a second user input, through the user interface, selecting the type of the object, identifying the first type as the type of the object based on the second user input corresponding to the first type, obtaining the second probability information through the second neural network model based on the second user input corresponding to the second type, and identifying the type of the object based on the second probability information.

The second probability information may include a third probability of the object corresponding to the first type and a fourth probability of the object corresponding to the second type, and the method may further include identifying the first type as the type of the object based on the third probability being greater than the fourth probability.

The method may further include displaying the user interface based on the third probability being less than the fourth probability, receiving a third user input, through the user interface, selecting the type of the object, and identifying the type of the object based on the third user input.

The user interface may include a first item corresponding to the first type, and a second item corresponding to the second type, and the method may further include determining at least one of a size of the first item, a transparency of the first item, a size of the second item, and a transparency of the second item based on a size of the third probability and a size of the fourth probability.

The method may further include storing the plurality of third images and the plurality of fourth images, and updating the plurality of third images stored in the memory based on the first image based on the third user input corresponding to the first type.

The method may further include storing information on fifth probabilities of each of the plurality of third images corresponding to the first type, and updating the plurality of third images stored in the memory by replacing a third image corresponding to a probability with the first image and storing the first image in the memory based on the third probability being greater than one of the fifth probabilities.

The method may further include increasing the first threshold value by a preset value based on the first probability being greater than the second probability, the third probability being less than the fourth probability, and the third user input corresponding to the second type.

### BRIEF DESCRIPTION OF DRAWINGS

The above and other aspects and features of the present disclosure will become more apparent by describing in detail one or more embodiments thereof with reference to the attached drawings, in which.

FIG. 1 is a view provided to explain an electronic apparatus, a first neural network model, and a second neural network model according to one or more embodiments;

FIG. 2 is a flowchart showing a control method of an electronic apparatus according to one or more embodiments;

FIG. 3 is a flowchart showing a provision of a user interface according to one or more embodiments;

FIG. 4 is a flowchart showing a provision of a user interface according to one or more embodiments;

FIG. 5 is a view showing a user interface according to one or more embodiments;

FIG. 6 is a flowchart showing an update of sample data according to one or more embodiments;

FIG. 7 is a flowchart showing an update of a first threshold value according to one or more embodiments;

FIG. 8 is a block diagram showing a configuration of an electronic apparatus according to one or more embodiments; and

FIG. 9 is a block diagram showing a configuration of an electronic apparatus in detail according to one or more embodiments.

### DETAILED DESCRIPTION

Embodiments of the disclosure may be modified in various different forms, and there may be various embodiments. Accordingly, specific embodiments are illustrated in drawings, and described specifically in the detailed description. However, it is to be understood that the various embodiments are not intended to limit the scope of the disclosure to a specific embodiment but they are to be interpreted as including various modifications, equivalents and/or alternatives of the embodiments set forth herein. In the drawings, like reference numerals may be used to indicate like elements.

In describing the disclosure, in case specific descriptions of known functions or configurations to which the disclosure pertains make the gist of the disclosure unnecessarily vague, detailed descriptions thereof are omitted.

Additionally, the embodiments hereinafter may be modified in various different forms, and it is to be understood that the scope of the technical spirit of the disclosure is not limited to the embodiments hereinafter. Rather, the embodiments are provided to make the disclosure thorough and complete and to fully convey the technical spirit of the disclosure to one skilled in the art.

Terms as used herein are merely used to describe a specific embodiment, and are not intended to limit the scope of the right for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and not exclude the presence of additional features.

In the disclosure, expressions such as “A or B,” “at least one of A and/or B,” or “one or more of A and/or B” may include all possible combinations of items listed together. For example, “A or B,” “at least one of A and B,” or “at least one of A or B” may refer to all cases including (1) at least one A, (2) at least one B, or (3) both of at least one A and at least one B.

In the disclosure, the expression “1st”, “2nd”, “first”, or “second”, and the like may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may be connect to another element directly, or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

In the disclosure, the expression “configured to... (or set to . . . )” used in the disclosure may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to . . . (or set to . . . )” may not necessarily mean “being specifically designed to” in terms of hardware.

Rather, in certain circumstances, the expression “a device configured to . . . ” may mean being capable of performing . . . by the device together with another device or component. For example, the phrase “a processor configured (or set) to perform A, B and C” may mean an exclusive processor (e.g., an embedded processor) for performing corresponding functions or a generic-purpose processor (e.g., a CPU or an application processor) capable of performing corresponding functions by executing one or more software programs stored in a memory device.

Regarding the embodiments, the term “module” or “unit” may perform at least one function or operation, and be implemented by hardware or software or by a combination of hardware and software. In addition, a plurality of “modules” or a plurality of “units” may be integrated into at least one module and be implemented as at least one processor except for a “module” or a “unit” that needs to be implemented by specific hardware.

Meanwhile, various elements and regions in the drawings are schematically illustrated. Accordingly, the technical spirit of the disclosure is not limited by relative sizes or distances illustrated in the accompanying drawings.

Hereinafter, embodiments according to the disclosure are described in detail with reference to the accompanying drawings so those skilled in the art to which the disclosure pertains may implement the embodiments readily.

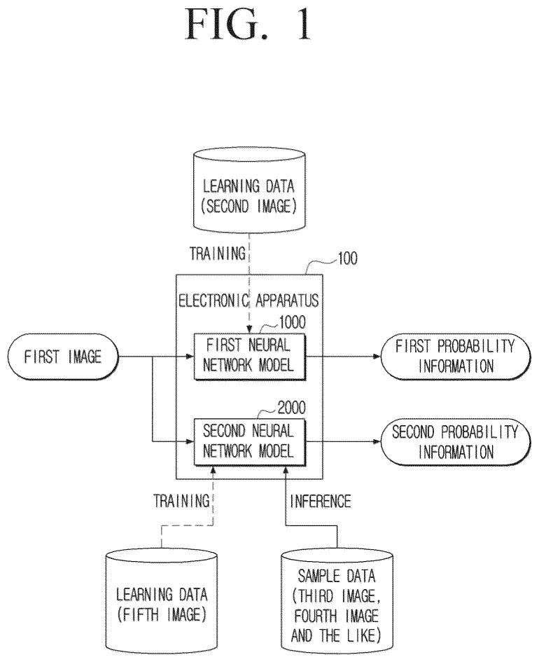

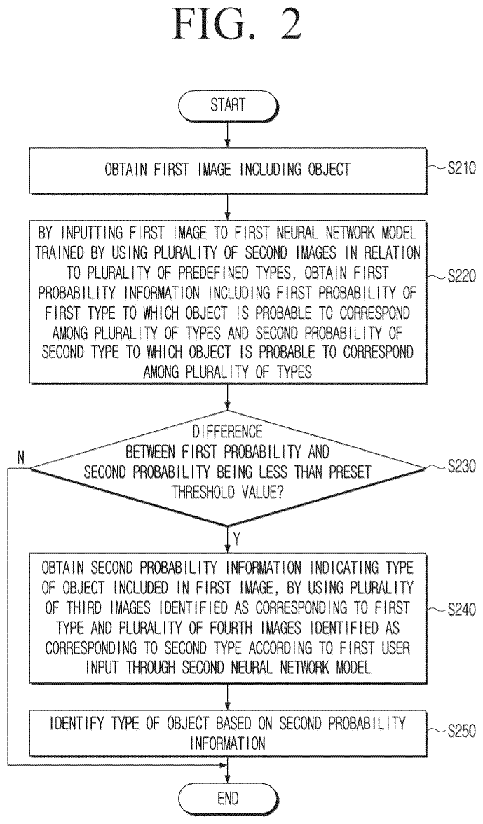

FIG. 1 is a view provided to explain an electronic apparatus 100, a first neural network model, and a second neural network model according to one or more embodiments. FIG. 2 is a flowchart showing a control method of an electronic apparatus 100 according to one or more embodiments, and description is provided hereinafter with reference to FIG. 1 and FIG. 2.

The electronic apparatus 100 may be an apparatus capable of identifying the type of an object included in an image. For example, the electronic apparatus 100 may be various types of apparatuses such as a smartphone, a tablet personal computer (PC), a television (TV), a refrigerator, a washing machine and the like, and the type of an electronic apparatus 100 is not limited.

The electronic apparatus 100 may identify the type of an object included in an image by using at least one of the first neural network model and the second neural network model. As illustrated in FIG. 1, both the first neural network model and the second neural network model may be implemented to be included in an electronic apparatus 100, in an on-device form. However, even in the case where at least one of the first neural network model and the second neural network model is included in an external apparatus such as a server and the like while an electronic apparatus 100 is connected to the external apparatus such as a server and the like, various embodiments described hereinafter may be applied in the same way.

The first neural network model may be a model that is trained to identify the type of an object included in an image based on relatively large amounts of data. For example, the first neural network model may be trained based on learning data including a plurality of images in relation to a plurality of predefined types and a label in relation to the plurality of images. For example, the first neural network model may include a neural network such as a convolutional neural network (CNN) and the like. For example, the first neural network model may be a normal object recognition model. The first neural network model may be referred to as an object recognition model, or a vision recognition model and the like, and to highlight a difference between the first neural network model and the second neural network model, may also be referred to as a deep neural network model DNN model and the like. For example, the first neural network model may be determined relative to the second neural network model in a relationship between the first neural network model and the second neural network model described hereinafter.

The second neural network model may be a model that is capable of identifying the type of an object included in an image by using relatively small amounts of data. For example, the second neural network model may also use large amounts of data at a time of pre-training, but after the pre-training, may use relatively small amounts of data (e.g., five sheets of images) to identify a specific type of image. For example, the second neural network model may be a neural network model that is referred to as a so-called few-shot learning model. For example, for training of the second neural network model, a method such as meta-learning or a prototype network and the like may be used.

The first neural network model has an advantage of relatively high accuracy, but in the case where a distribution of data used for training and a distribution of data input actually differ, there is a problem (the so-called dataset drift) that accuracy may deteriorate. On the other hand, in the case where of data having a distribution similar to a distribution of learning data are input, accuracy of the second neural network model may be less than accuracy of the first neural network model, but in the case where a distribution of data used for training and a distribution of data input are different, the second neural network model has an advantage of recognizing a new type of data more rapidly.

The electronic apparatus 100 according to one or more embodiments may use the second neural network model together with the first neural network model, and accordingly, various embodiments of identifying the type of an object included in an image by using the second neural network model together with the first neural network model are described hereinafter with reference to FIG. 2.

As illustrated in FIG. 2, the electronic apparatus 100 may obtain a first image including an object (S210). In one or more embodiments, the first image may be an image that becomes an object of an object identification. For example, the first image, as illustrated in FIG. 1, may be an image that is input to the first neural network model and the second neural network model. The term of first image may be replaced with a term such as image data or an input image, and the like.

Hereinafter, in the case whew an object is simply indicated, the object may be an object included in the first image. Description is provided hereinafter under the assumption that one object is included in the first image, but various embodiments according to the disclosure may be applied in the same way even in the case where a plurality of objects is included in the first image.

The electronic apparatus 100 may input the first image to the first neural network model trained by using a plurality of second images in relation to a plurality of predefined types, to obtain first probability information including a first probability of a first type to which the object is probable to correspond among the plurality of types and a second probability of a second type to which the object is probable to correspond among the plurality of types (S220).

The plurality of “types may be all types that become objects of an object classification performed the first neural network model, and may be replaced with a term such as a plurality of classes or a plurality of domains, and the like. As illustrated in FIG. 1, the plurality of second images may be images used for training of the first neural network model, and may include a plurality of images of each of a plurality of types. For example, the plurality of second images may include a plurality of images corresponding to a type of apple, a plurality of images corresponding to a type of peach, and the like.

As probability information obtained by the first neural network model, the first probability information may include information on a probability in which the object included in the first image is probable to correspond to each of the plurality of types. For example, since the first probability information includes information as to which type among the plurality of types is a type to which the object included in the first image is most probable to correspond, the first probability information may also be expressed as results of an object identification of the first neural network model.

In particular, the first probability information may include a first probability of a first type to which the object is probable to correspond among the plurality of types, and a second probability of a second type to which the object is probable to correspond among the plurality of types.

Herein, the first type may be a type (a Top 1 type) that is identified through the first neural network model as a type to which the object is most probable to correspond among the plurality of types, and the second type may be a type (a Top 2 type) that is identified through the first neural network model as a type to which the object is second most probable to correspond among the plurality of types. Hereinafter, description is provided for convenience of description under the assumption that the first probability information includes the first probability of the first type that is the Top 1 type, and the second probability of the second type that is the Top 2 type.

However, in one or more embodiments, the first probability information is not limited thereto, and for example, may include a first probability of a first type to which the object is most probable to correspond among the plurality of types, a second probability of a second type to which the object is second most probable to correspond among the plurality of types, and a third probability of a third type to which the object is third most probable to correspond among the plurality of types.

In the case where a difference between the first probability and the second probability is less than a preset first threshold value (S230-Y), the electronic apparatus 100 may obtain second probability information indicating a type of an object included in the first image, by using a plurality of third images identified as corresponding to the first type and a plurality of fourth images identified as corresponding to the second type, according to a first user input, through the second neural network model (S240).

The first threshold value may be a value that is preset to evaluate reliability of the first neural network model based on the difference between the first probability and the second probability and be changed by, for example, a developer or a user. For example, when the difference between the first probability and the second probability is equal to or greater than the first threshold value in the case where the first threshold value is 0.3, the first probability is 0.8, and the second probability is 0.1, the first neural network model may be considered to classify the object into a specific type clearly, and the reliability of results of an object identification of the first neural network model may be considered to be relatively high.

When the difference between the first probability and the second probability is less than the first threshold value in the case where the first threshold value is 0.3, the first probability is 0.5, and the second probability is 0.4, the first neural network model may not be considered to classify the object into a specific type, and the reliability of the first neural network model may be considered to be relatively low.

Accordingly, in the case where the difference between the first probability and the second probability is less than the preset first threshold value, the electronic apparatus 100 may identify the object by using the second neural network model, rather than depending only on the first neural network model. For example, the electronic apparatus 100, as illustrated in FIG. 1, may input the first image to the second neural network model, and perform inference of a type of the object by using sample data, and obtain the second probability information indicating the type of the object included in the first image.

In the case where the first probability information includes a first probability of a first type to which the object is most probable to correspond among the plurality of types, a second probability of a second type to which the object is second most probable to correspond among the plurality of types, and a third probability of a third type to which the object is third most probable to correspond among the plurality of types, the processor may determine whether to obtain second probability information through the second neural network model based on whether a difference between the first probability and the second probability is less than a preset first threshold value, or determine whether to obtain second probability information through the second neural network model by comparing a difference between the first probability and the second probability and a difference between the first probability and the third probability respectively with preset threshold values.

The second probability information may denote probability information obtained by the second neural network model, and include information on a probability in which an object included in the first image is probable to correspond to a specific type. For example, since the second probability information includes information as to which type is a type to which the object included in the first image is most probable to correspond among the plurality of types, the second probability information may also be expressed as results of an object identification of the second neural network model. In particular, the second probability information may include a third probability in which the object is probable to correspond to the first type, and a fourth probability in which the object is probable to correspond to the second type.

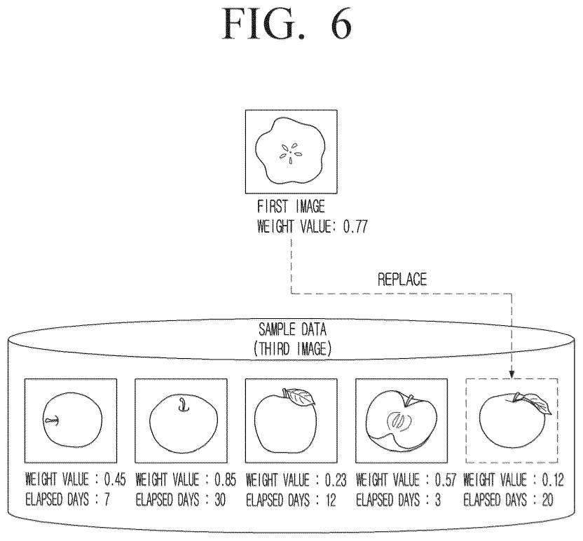

The sample data refers to a collection of images that are identified as corresponding to a specific type by the user. The sample data may be stored in memory of the electronic apparatus 100, and updated according to various embodiments described hereinafter with reference to FIG. 6. Images that are identified as corresponding to a specific type by the user before the first image that becomes an object of an object identification is obtained and are stored in the memory of the electronic apparatus 100 may be used to identify the object included in the first image. Since the sample data include the images identified by the user, the sample data may also be referred to as user data.

For example, the second neural network model may use images that are identified as corresponding to each of the types included in the first probability information by the user, in the sample data, to identify the object included in the first image. For example, as illustrated in FIG. 1, the plurality of third images identified as corresponding to the first type and the plurality of fourth images identified as corresponding to the second type according to a first user input that is input before the first image is obtained may be included in the sample data and stored in the memory of the electronic apparatus 100.

The number of the plurality of third images and the number of the plurality of fourth images may be preset (e.g., five), but is not limited thereto. Additionally, the number of the plurality of third images stored and the number of the plurality of fourth images stored may not be limited, but among the images, a predetermined number of images that are most probable to correspond to the first type or the second type may be used for inference of the second neural network model. In the case where the number of the plurality of third images and the number of the plurality of fourth images are determined, when images in a number less than the determined number stored in the memory, the electronic apparatus 100 may not use the second neural network model.

The second neural network model may obtain the second probability information based on a first similarity between the first image and the plurality of third images and a second similarity between the first image and the plurality of fourth images.

For example, the second neural network model may calculate and/or obtain the first similarity as to how much the first image is similar to the plurality of third images, by extracting and comparing a feature vector of each of the first image and the plurality of third images. Additionally, the second neural network model may calculate the second similarity as to how much the first image is similar to the plurality of fourth images, by extracting and comparing a feature vector of each of the first image and the plurality of fourth images. Further, the electronic apparatus 100 may calculate a third probability in which the object is probable to correspond to the first type and a fourth probability in which the object is probable to correspond to the second type based on the first similarity and the second probability.

The second neural network model, as illustrated in FIG. 1, may be trained based on a plurality of fifth images that is different from the plurality of second images used for training of the first neural network model. For example, in the case where the plurality of second images used for training of the first neural network model includes a plurality of images corresponding to a type of apple, and a plurality of images corresponding to a type of peach, the second neural network model may be trained by using images corresponding to another type such as an airplane, a train and the like rather than using images corresponding to the types of apple and peach. This is to prevent overfitting and recognize a new type of data rapidly.

In the case where images corresponding to the type of apple or peach are identified by the user of the electronic apparatus 100 after the second neural network model is trained by using the images corresponding to an airplane, a train“ and the like, the electronic apparatus 100 may store the identified images as sample data (the plurality of third images or the plurality of fourth images), and then in the case where an image of apple or a peach is input as an identification object, may obtain second probability information indicating a type of an object included in the input image, through the second neural network model (by using the plurality of third images or the plurality of fourth images).

When obtaining the second probability information, the electronic apparatus 100 may identify the type of the object based on the second probability information (S250). For example, since a difference between the first probability and the second probability being less than a preset first threshold value may indicate that reliability of the first neural network model is considered low, the electronic apparatus 100 may identify the type of the object included in the first image based on the second probability information obtained through the second neural network model that is a few-shot learning model.

According to one or more embodiments, in the case where the third probability included in the second probability information is equal to or greater than the fourth probability included in the second probability information, the electronic apparatus 100 may identify the first type as the type of the object. In the case where the third probability included in the second probability information is less than the fourth probability in the second probability information, the electronic apparatus 100 may identify the second type as the type of the object.

According to one or more embodiments, the electronic apparatus 100 may identify the type of the object based on results of comparison between the first probability information and the second probability information. For example, a difference between the first probability and the second probability being less than a preset first threshold value may indicate that reliability of the first neural network model is considered relatively low, but the electronic apparatus 100 may also identify the type of the object by referring to the first probability information together with the second probability information. For example, in the case where the first probability is equal to or greater than the second probability and the third probability is equal to or greater than the fourth probability, the electronic apparatus 100 may identify the first type as the type of the object. In the case where the first probability is less than the second probability and the third probability is less than the fourth probability, the electronic apparatus 100 may identify the second type as the type of the object.

According to the embodiments described above with reference to FIGS. 1 and 2, the electronic apparatus 100 may obtain results of an object identification with relatively high accuracy by using images identified according to a user input through a few-shot learning model (the second neural network model), in the case where reliability of results of an object identification using an object recognition model (the first neural network model) using a DNN is not high.

In particular, in the case where a distribution of data used for training and a distribution of data input are different, the electronic apparatus 100 may perform an improved accurate object recognition of an image having a new distribution by using the few-shot learning model without additional learning of a DNN model even in a device environment with a difficulty in additional learning.

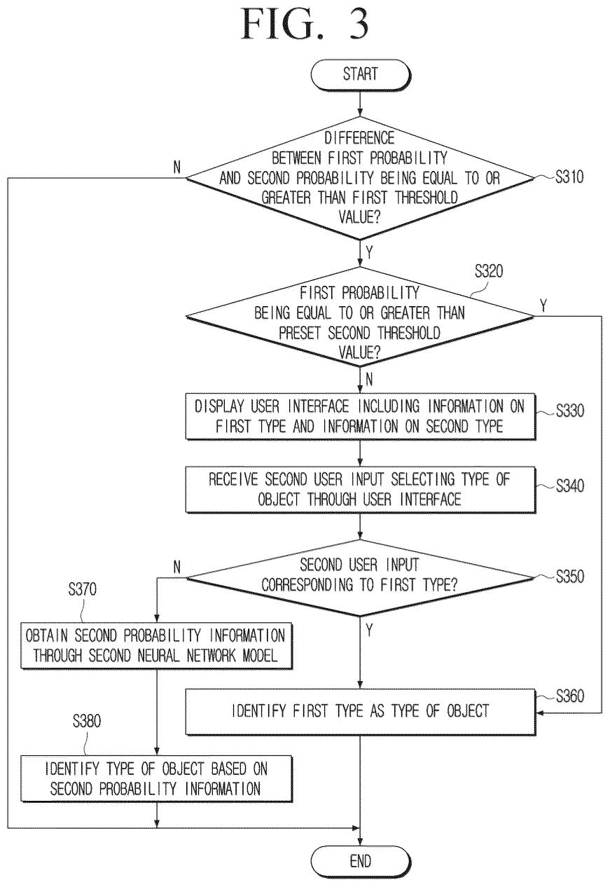

FIG. 3 is a flowchart showing a provision of a user interface according to one or more embodiments.

The case (S230-Y, S310-N), where the difference between the first probability of the first type to which the object is probable to correspond among the plurality of types and the second probability of the second type to which the object is probable to correspond among the plurality of types is less than the preset first threshold value, is described above, but one or more embodiments in which a difference between the first probability and the second probability is equal to or greater than the first threshold value are described with reference to FIG. 3.

In the case where the difference between the first probability and the second probability is equal to or greater than the first threshold value (S310-Y) and the first probability is equal to or greater than a preset second threshold value (S320-Y), the electronic apparatus 100 may identify the first type as the type of the object (S360).

Herein, the second threshold value may be a value that is preset to evaluate reliability of the first neural network model based on the first probability, and be changed by a developer or a user. For example, when the difference between the first probability and the second probability is equal to or greater than the first threshold value while the first probability itself is less than the second threshold value in the case where the first threshold value and the second threshold value are 0.3 and 0.75 respectively, the first probability is 0.8, and the second probability is 0.1, the first neural network model may be considered to classify the object into the first type clearly. Accordingly, since reliability of the first neural network model may be considered to be relatively very high, the electronic apparatus 100 may confirm that the first type is identified as the type of the object.

In the case where the difference between the first probability and the second probability is equal to or greater than the first threshold value (S310-Y) while the first probability is less than the second threshold value (S320-N), the electronic apparatus 100 may identify the type of the object based on a user input.

For example, when the difference between the first probability and the second probability is equal to or greater than the first threshold value while the first probability is less than the second threshold value in the case where the first threshold value and the second threshold value are 0.3 and 0.75 respectively, the first probability is 0.6, and the second probability is 0.2, it may be difficult to determine that the first neural network model classifies the object into the first type. For example, since this is not the case where reliability of the first neural network model is considered relatively very high, the electronic apparatus 100 may identify the type of the object based on the user input without confirming the first type as the type of the object.

For example, in the case where the difference between the first probability and the second probability is equal to or greater than the first threshold value (S310-Y) while the first probability is less than the second threshold value (S320-N), the electronic apparatus 100 may display a user interface including information on the first type and information on the second type (S330).

For example, the user interface may include identification information on the first type and identification information on the second type. Additionally, the user interface may include the first probability and the second probability. The information on the first type and the information on the second type may be provided in the form of at least one of a text and an image.

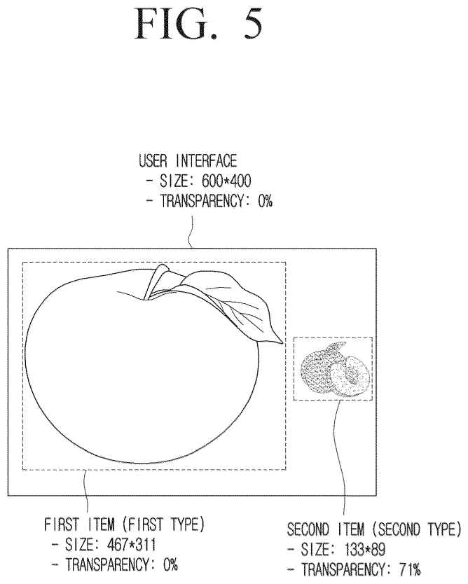

For example, the electronic apparatus 100 may display information indicating that the name of the first type is apple and information indicating that the name of the second type is peach in the user interface. In addition, the electronic apparatus 100 may also display information indicating that a probability in which the object is probable to correspond to apple is 0.6 and information indicating that a probability in which the object is probable to correspond to peach is 0.2 in the user interface. The user interface is described in greater detail with reference to FIG. 5.

The electronic apparatus 100 may receive a second user input selecting the type of the object through the user interface (S340). For example, in the case where the information indicating that the name of the first type is apple and the information indicating that the name of the second type is peach are displayed in the user interface, the electronic apparatus 100 may receive the second user input corresponding to one of a user feedback indicating that the object included in the first image is an apple, a user feedback indicating that the object included in the first image is a peach, and a user feedback indicating that the object included in the first image is neither apple nor peach.

In the case where the second user input corresponds to the first type (S350-Y), the electronic apparatus 100 may identify the first type as the type of the object (S360). In the above example, when receiving the user feedback indicating that the object included in the first image is an apple, the electronic apparatus 100 may identify the type of the object as an apple.

For example, in the case where the first probability information indicates that the first type is a type with a highest probability as assumed above while the user feedback also indicates that the object is the first type, this may the case where the first probability information output by the first neural network model matches the user feedback. Accordingly, the electronic apparatus 100 may identify the first type as the type of the object without an additional process.

In the case where the second user input corresponds to the second type (S350-N), the electronic apparatus 100 may obtain second probability information through the second neural network model (S370), and based on the second probability information, identify the type of the object (S380). In the above example, when receiving the user feedback indicating that the object included in the first image is a peach, the electronic apparatus 100 may obtain the second probability information through the second neural network model, and based on the second probability information, identify the type of the object, as described above with reference to FIGS. 1 and 2, rather than identifying the type of the object as a peach.

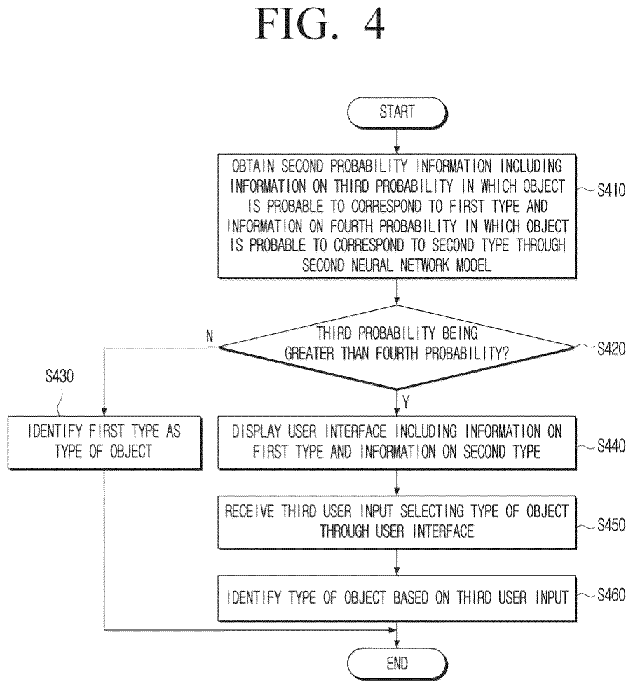

For example, in the case where the first probability information indicates that the first type is a type with a highest probability as assumed above while the user feedback indicates that the object is the second type, this may the case where the first probability information output by the first neural network model does not match the user feedback. Accordingly, the electronic apparatus 100 may use the second neural network model for an additional verification process. An embodiment identifying an object by using the second probability information obtained through the second neural network model is described in greater detail with reference to FIG. 4. Certainly, depending on embodiments, the second type may be identified as the type of the object as indicated by the user feedback, based on the user input.

According to the embodiments described above with reference to FIG. 3, the electronic apparatus 100 may obtain results of an object identification with greater accuracy by using the user input or the second neural network model for additional verification, even in the case where reliability of results of an object identification using the first neural network model is relatively high.

FIG. 4 is a flowchart showing a provision of a user interface according to one or more embodiments.

The embodiment of identifying the type of the object by receiving the second user input through the user interface and by using the first probability information and the second user input together is described above in the case where the first probability information is obtained through the first neural network model. An embodiment of identifying the type of the object by receiving a third user input through the user face and by using the second probability information and the third user input together is described hereinafter in the case where the second probability information is obtained through the second neural network model.

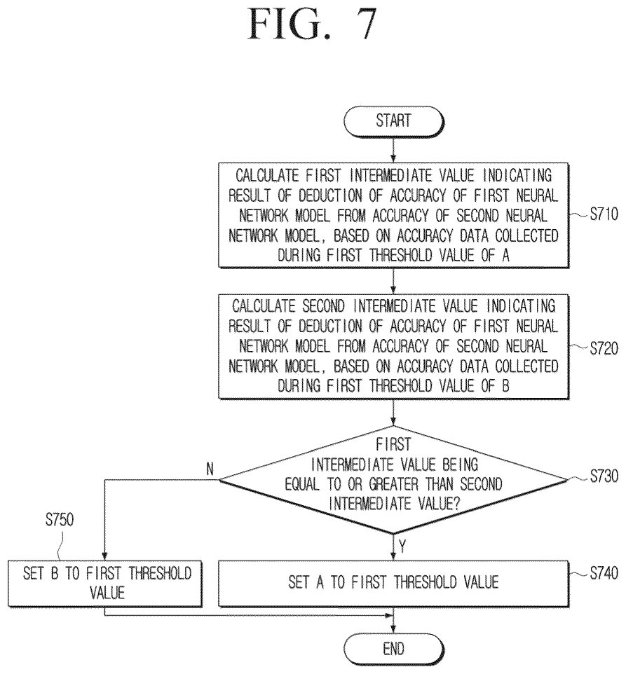

First, the case where the second neural network model is used may include a case where reliability of results of an object identification using the first neural network model is not high, and a case where it is difficult to confirm results of an object identification despite use of the first neural network model and the user input. In addition, the second neural network model may be used in the case where the amount of sample data is equal to or greater than a predetermined amount, the case where the number of updates of sample data is equal to or greater than a predetermined number, or the case where accuracy of the second neural network model is identified as being greater than accuracy of the first neural network model, and the like, regardless of the first neural network model and results of an object identification according to the user input. An embodiment of comparing between reliability (or accuracy) of the first neural network model and reliability (or accuracy) of the second neural network model is described hereinafter with reference to FIG. 7.

As described above, the electronic apparatus 100 may obtain the second probability information including information on the third probability in which the object is probable to correspond to the first type and information on the fourth probability in which the object is probable to correspond to the second type through the second neural network model (S410), and the second probability information may include the third probability in which an object is probable to correspond to the first type and the fourth probability in which an object is probable to correspond to the second type.

In the case where the third probability is greater than the fourth probability (S420-Y), the electronic apparatus 100 may identify the first type as the type of the object (S430). For example, in the case where the first probability information indicates that the first type is a type with a highest probability as assumed above while the second probability information also indicates that the first type is a type with a highest probability, this may be the case where the first probability information output by the first neural network model matches the second probability information output by the second neural network model. Accordingly, the electronic apparatus 100 may identify the first type as the type of the object.

In the case where the third probability is less than the fourth probability (S420-N), the electronic apparatus 100 may display a user interface including the information on the third probability and the information on the fourth probability (S440). The electronic apparatus 100 may receive a third user input selecting the type of the object through the user interface (S450). Additionally, the electronic apparatus 100 may identify the type of the object based on the third user input (S460).

For example, in the case where the first probability information indicates that the first type is a type with a highest probability as assumed above while the second probability information indicates that the second type is a type with a highest probability, this may be the case where the first probability information output by the first neural network model does not match the second probability information output by the second neural network model. Accordingly, the electronic apparatus 100 may receive a user input for an additional verification process.

According to the embodiments described above with reference to FIG. 4, the electronic apparatus 100 may obtain results of an object identification with relatively high accuracy by using the second neural network model, and obtain results of an object identification with greater accuracy through additional verification using the user input together with the second neural network model.

In addition to the embodiments described above, various embodiments of cross-verifying results of an object identification by using at least two or more of the first neural network model, the second neural network model and the user input may be implemented according to the present disclosure.

In the case of an image (i.e., a first image) as input data, the embodiments of using the first neural network model and the second neural network model for identifying the type of the object included in the image by the electronic apparatus 100 are described above, but the subject matter of one or more embodiments may also be applied to a voice recognition in the same way.

For example, the electronic apparatus 100 may obtain a voice signal, and by inputting the voice signal to a DNN model trained to identify a text corresponding to a voice signal, may obtain a first probability in which the voice signal is probable to correspond to a first text and a second probability in which the voice signal is probable to correspond to a second text. In the case where a difference between the first probability and the second probability is less than a preset first threshold value, the electronic apparatus 100 may obtain second probability information indicating a type of an object included in the voice signal through a few-shot learning model by using a sample voice signal identified as corresponding to the first text and a sample voice signal identified as corresponding to the second text according to a user input. Additionally, the electronic apparatus 100 may identify the text corresponding to the voice signal based on the second probability information.

FIG. 5 is a view showing a user interface according to one or more embodiments.

The user interface may include a first item corresponding to a first type and a second item corresponding to a second type. The user interface, as illustrated in FIG. 5, may include an apple-shaped first item corresponding to a first type of apple and a peach-shaped second item corresponding to a second type of peach.

The electronic apparatus 100 may determine at least one of a size and transparency of the first item and the second item, based on a size of the first probability and a size of the second probability. Additionally, the electronic apparatus 100 may display the user interface based on at least one of the determined size and transparency of the first item and the second item.

For example, in the case where the first probability is 0.7 while the second probability is 0.2, the electronic apparatus 100 may determine the size of the first item as 467*311, and determine the size of the second item as 133*89 by dividing the size 600*400 (hereinafter, width*length) of the user interface in proportion to the size of the first probability and the size of the second probability. Further, the electronic apparatus 100 may determine the transparency of the second item as 100×0.2/0.7*100=71% to reflect the size of the first probability and the size of the second probability. At this time, the transparency of the first item and transparency of the background of the user interface may be maintained at 0 %.

In addition, the electronic apparatus 100 may distinguish a position, color and the like of the first item and the second item, and display the position, color, and the like, in the user interface, may apply a blur effect and the like to at least one of the first item and the second item, and may display the first probability and the second probability together with the first item and the second item.

The electronic apparatus 100 may display the size and transparency and the like of the first item and the second item identically and may not display the first probability information and the second probability information, such that the user may select the type of the object without considering the probability information provided through the first neural network model or the second neural network model.

According to the embodiments described above with reference to FIG. 5, the electronic apparatus 100 may provide the probability information obtained through the first neural network model or the second neural network model by visualizing the same in an intuitive manner through the user interface, and may obtain results of an object identification with high accuracy by using the user input received through the user interface.

FIG. 6 is a flowchart explaining an update of sample data according to one or more embodiments.

As described above, the sample data may refer to a collection of images identified as corresponding to a specific type by the user, and be stored in the memory of the electronic apparatus 100. In the sample data, images corresponding to various types may be stored, but hereinafter, a plurality of third images identified by the user as corresponding to the first type, and a plurality of fourth images identified by the user as corresponding to the second type are described for convenience of description.

Before a first image that becomes an object of an object identification is obtained, the plurality of third images and the plurality of fourth images may be stored in memory (e.g., the memory of an electronic apparatus 100 or memory of an external apparatus), and in the case where the first image is identified as corresponding to the first type or the second type, the plurality of third images or the plurality of fourth images stored in the memory may be updated.

For example, in the case where the first image is identified as corresponding to the first type, the electronic apparatus 100 may update the plurality of third images stored in the memory based on the first image. For example, in the case where a third user input is received through the user interface as a result of provision of the user interface, the electronic apparatus 100 may update the plurality of third images stored in the memory based on the first image when the third user input corresponds to the first type.

The update of the plurality of third images based on the first image may denote replacing one of the plurality of third images with the first image. For example, information on fifth probabilities in which each of the plurality of third images is probable to correspond to the first type may be stored in the memory. Additionally, in the case where the third probability is greater than one of the fifth probabilities, the electronic apparatus 100 may update the plurality of third images stored in the memory by replacing a third image corresponding to one of the fifth probabilities with the first image and storing the same in the memory.

Information on a weight value obtained based on the fifth probabilities in which each of the plurality of third images is probable to correspond to the first type and information on days elapsed from the day when each of the plurality of third images is obtained may be stored in the memory. Herein, the information on a weight value may be determined based on at least one of the first probability information obtained through the first neural network model, the second probability information obtained through the second neural network model and the user input that is input through the user interface.

As in the example of FIG. 6, in the case where a weight value of each of the plurality of third images is 0.45, 0.85, 0.23, 0.57 and 0.12, the electronic apparatus 100 may replace a third image of a least weight value of 0.12 with the first image. In addition, the electronic apparatus 100 may replace a third image having longest elapsed days, e.g., a third image having elapsed days of 30 with the first image. When there is a third image having elapsed days equal to or greater than preset threshold days (e.g., 100 days) among the plurality of third images, the third image having elapsed days equal to or greater than the preset threshold days may be replaced with the first image, regardless of a weight value.

According to the embodiments described above with reference to FIG. 6, the electronic apparatus 100 may update the sample data by using images in which the type of the object is identified according to a user input, and improve accuracy of an object identification of the second neural network model further.

FIG. 7 is a flowchart showing an update of a first threshold value according to one or more embodiments.

As described above, the first threshold value may denote a value that is preset to evaluate reliability of the first neural network model based on a difference between the first probability and the second probability, and may be changed by a developer or a user. In addition, the first threshold value may be changed based on collected data.

The electronic apparatus 100 may calculate a first intermediate value indicating a result of a deduction of accuracy of the first neural network model from accuracy of the second neural network model, based on accuracy data that are collected while the first threshold value is A (S710). Additionally, the electronic apparatus 100 may calculate a second intermediate value indicating a result of a deduction of accuracy of the first neural network model from accuracy of the second neural network model, based on accuracy data that are collected while the first threshold value is B (S720).

Herein, the accuracy data may denote information indicating which of the first neural network model and the second neural network model outputs probability information corresponding to results of an identification of an object included in a finally input image.

Since the first intermediate value indicates a result of a deduction of accuracy of the first neural network model from accuracy of the second neural network model for a first period in which the first threshold value is set to A, a greater first intermediate value may be that the accuracy of the second neural network model is greater than the accuracy of the first neural network model while the first threshold value is set to A. Since the second intermediate value indicates a result of a deduction of accuracy of the first neural network model from accuracy of the second neural network model for a second period in which the first threshold value is set to B, a greater second intermediate value may mean that the accuracy of the second neural network model is greater than the accuracy of the first neural network model while the first threshold value is set to B.

In the case where the first intermediate value is equal to or greater than the second intermediate value (S730-Y), the electronic apparatus 100 may set A to the first threshold value (S740). For example, the first intermediate value being greater than the second intermediate value may mean that the accuracy of the second neural network model is greater for the first period in which the first threshold value is set to A than for the second period in which the first threshold value is set to B. Accordingly, the electronic apparatus 100 may set A, which is the first threshold value set for the first period, to the firth threshold value, and identify an object included in an image that is input afterwards, to identify the object based on the accuracy of the second neural network model.

FIG. 7 is a view under the assumption that A is set to the first threshold value in the case where the first intermediate value is identical with the second intermediate value, but in the case where the first intermediate value is identical with the second intermediate value, setting A to the first threshold value or setting B to the first threshold value depends on embodiments.

In the case where the first intermediate value is less than the second intermediate value (S730-N), the electronic apparatus 100 may set B to the first threshold value (S750). For example, the first intermediate value being less than the second intermediate value may mean that the accuracy of the second neural network model is greater for the second period in which the first threshold value is set to B than for the first period in which the first threshold value is set to A. Accordingly, the electronic apparatus 100 may set B, which is the first threshold value set for the second period, to the firth threshold value, and identify an object included in an image that is input afterwards, to identify the object based on the accuracy of the second neural network model.

The embodiment of changing the first threshold value based on accuracy data collected, in the case where the accuracy data are collected for a predetermined period is described above, but depending on embodiments, the first threshold value may be changed based on one input image. For example, in the case where results of an object identification of the first neural network model conflict with results of an object identification of the second neural network model, the electronic apparatus 100 may change the first threshold value to obtain results of an identification of an object by using a neural network model having output results of an object identification matching a user input.

For example, in the case where the first image described with reference to FIGS. 1-6 is obtained, when the first probability obtained through the first neural network model is greater than the second probability obtained through the first neural network model (that is, results of an object identification of the first neural network model indicate that the first type is a Top 1 type), the third probability obtained through the second neural network model is less than the fourth probability obtained through the second neural network model (that is, results of an object identification of the second neural network model indicate that the second type is a Top 1 type), and the third user input corresponds to the second type (that is, the third user input indicates that the first type is a Top 1), the electronic apparatus 100 may increase the first threshold value by a preset value.

For example, since this is the case where reliability of the second neural network model is greater than reliability of the first neural network model, the electronic apparatus 100 may increase the first threshold value by a preset value to determine the reliability of the first neural network model more strictly. For example, in the case of a first threshold value of 0.3, when the reliability of the second neural network model is identified as being greater than the reliability of the first neural network model, the electronic apparatus 100 may adjust the first threshold value upwards to identify a type of an object by using the first neural network model, in the case where a difference between the first probability and the second probability is equal to or greater than 0.31.

According to the embodiments described above with reference to FIG. 7, the electronic apparatus 100 may obtain results of an object identification with greater accuracy later, by comparing the accuracy of the first neural network model and the accuracy of the second neural network model and changing the first threshold value that is a criterion for a calculation of the reliability of the first neural network model.

A control method of an electronic apparatus 100 according to the above-described embodiments may be implemented as a program and provided to an electronic apparatus 100. In particular, a program including the control method of an electronic apparatus 100 may be stored in a non-transitory computer readable medium and provided.

For example, in the non-transitory computer readable medium including a program executing the control method of an electronic apparatus 100, the method may include obtaining a first image including an object, by inputting the first image to a first neural network model that is trained by using a plurality of second images in relation to a plurality of predefined types, obtaining first probability information including a first probability of a first type to which the object is probable to correspond among the plurality of types and a second probability of a second type to which the object is probable to correspond among the plurality of types, based on a difference between the first probability and the second probability being less than a preset first threshold value, obtaining second probability information indicating a type of the object included in the first image, by using a plurality of third images identified as corresponding to the first type and a plurality of fourth images identified as corresponding to the second type, according to a first user input, through a second neural network model, and identifying the type of the object based on the second probability information.

The control method of an electronic apparatus 100 and the computer readable medium including a program executing the control method of an electronic apparatus 100 are briefly described above, but this is to avoid repetitive description, and certainly, various embodiment in relation to the electronic apparatus 100 may be applied to the control method of an electronic apparatus 100, and the computer readable medium including a program executing the control method of an electronic apparatus 100.

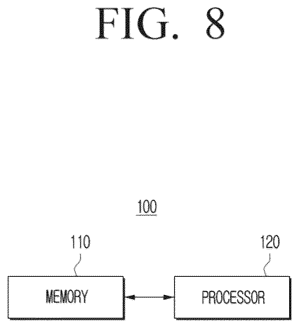

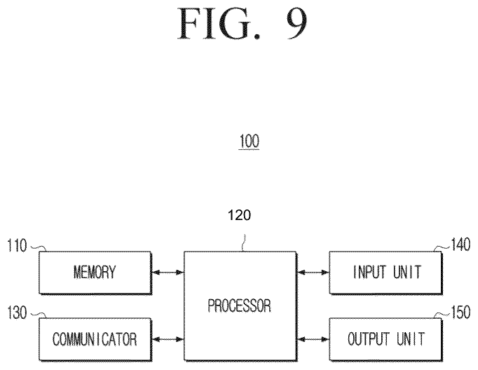

FIG. 8 is a block diagram briefly showing a configuration of an electronic apparatus 100 according to one or more embodiments, and FIG. 9 is a block diagram showing a configuration of an electronic apparatus 100 For example according to one or more embodiments.

As illustrated in FIG. 8, the electronic apparatus 100 according to one or more embodiments includes memory 110 and a processor 120. Additionally, as illustrated in FIG. 9, the electronic apparatus 100 according to one or more embodiments may further include a communicator (communication interface) 130, an input unit (input interface) 140 and an output unit (output interface) 150. However, the configurations illustrated in FIGS. 8 and 9 are provided only as examples, and embodiments are not limited thereto.

In the memory 110, at least one instruction in relation to the electronic apparatus 100 may be stored. Additionally, in the memory 110, an operating system (O/S) for driving the electronic apparatus 100 may be stored. Further, in the memory 110, various types of software programs or applications for the electronic apparatus 100 to operate according to various embodiments of the disclosure may be stored. Additionally, the memory 110 may include semiconductor memory such as flash memory and the like, or a magnetic storage medium and the like such as a hard disk and the like.

For example, in the memory 110, various types of software modules for the electronic apparatus 100 to operate according to various embodiments may be stored, and the processor 120 may control an operation of the electronic apparatus 100 by executing various types of software modules stored in the memory 110. That is, the memory 110 may be accessed by the processor 120 and in the memory 110, the processor 120 may perform reading/storing/correcting/deleting/updating and the like of data.

According to one or more embodiments, the term memory 110 may be used as a meaning including memory 110, ROM, RAM in a processor 120, or a memory card (e.g., a micro SD card, a memory stick) mounted in the electronic apparatus 100.

According to one or more embodiments, in the memory 110, a first image, first probability information, second probability information, sample data and the like may be stored. Additionally, in the memory 110, data on a first neural network model, data on a second neural network model, a first threshold value, a second threshold value, information on a user interface and the like may be stored.

In addition, various types of information required within a range for achieving the purpose of one or more embodiments may be stored in the memory 110, and information stored in the memory 110 may be received from an external apparatus or updated based on an input of the user.

The processor 120 controls entire operations of the electronic apparatus 100. For example, the processor 120 may be connected to a configuration of the electronic apparatus 100 including memory 110, a communicator 130, an input unit 140 and an output unit 150, and control the operations of the electronic apparatus 100 entirely, by executing at least one instruction stored in the above-described memory 110.

The processor 120 may be implemented in various ways. For example, the processor 120 may be implemented as at least one of an application specific integrated circuit (ASIC), an embedded processor, a microprocessor, hardware control logic, a hardware finite state machine (FSM), and a digital signal processor (DSP). The term processor 120 may include a central processing unit (CPU), a graphic processing unit (GPU), a microprocessor unit (MPU) and the like.

According to one or more embodiments, the processor 120 may obtain a first image including an object. The processor 120 may, by inputting the first image to a first neural network model that is trained by using a plurality of second images in relation to a plurality of predefined types, may obtain first probability information including a first probability of a first type to which the object is probable to correspond among the plurality of types and a second probability of a second type to which the object is probable to correspond among the plurality of types. Based on a difference between the first probability and the second probability being less than a preset first threshold value, the processor 120 may obtain second probability information indicating a type of the object included in the first image, by using a plurality of third images identified as corresponding to the first type and a plurality of fourth images identified as corresponding to the second type, according to a first user input, through a second neural network model. Additionally, the processor 120 may identify the type of the object based on the second probability information.

Since various embodiments based on a control of the processor 120 are described above with reference to FIGS. 1-7, repetitive description is avoided.

The communicator 130 may include circuitry, and perform communication with an external apparatus. For example, the processor 120 may receive various types of data or information from the external apparatus connected thereto through the communicator 130, and also transmit various types of data or information to the external apparatus.

The communicator 130 may include at least one of a WiFi module, a Bluetooth module, a wireless communication module, an NFC module and an ultra-wide band (UWB) module. For example, each of the WiFi module and the Bluetooth module may perform communication based on a WiFi method and a Bluetooth method. In the case where the WiFi module or the Bluetooth is used, various types of connection information such as an SSID and the like may be first transmitted and received, and are used to perform communication connection and then transmit and receive various types of information.

Additionally, the wireless communication module may perform communication according to various communication standards such as IEEE, Zigbee, 3rd Generation (3G), 3rd Generation Partnership Project (3GPP), Long Term Evolution (LTE), 5th Generation (5G) and the like. Further, the NFC module may perform communication based on a near field communication (NFC) method using a 13.56 MHz band among various RF-ID frequency bands such as 135 kHz, 13.56 MHz, 433 MHz, 860-960 MHz, 2.45 GHz and the like. Furthermore, the UWB nodule may measure time of arrival (ToA) that is time taken for a pulse to arrive at an object, and an angle of arrive (AoA) that is a pulse arrival angle in a transmitting device accurately, based on communication between UWB antennas, and accordingly, may recognize a distance and a position precisely in an indoor space, within an error range of dozens of centimeters.

According to one or more embodiments, the processor 120 may receive information on the first neural network model and information on the second neural network model from the external apparatus through the communicator 130. The processor 120 may obtain the first image by receiving the first image from the external apparatus through the communicator 130. In the case where at least one of the first neural network model and the second neural network model is included in the external apparatus, the electronic apparatus 100 may control the communicator 130 to transmit data on the first image to the external apparatus, and receive at least one of the first probability information and the second probability information from the external apparatus through the communicator 130.

The input unit 140 may include circuitry, and the processor 120 may receive a user instruction for controlling an operation of the electronic apparatus 100 through the input unit 140. For example, the input unit 140 may be comprised of elements such as a microphone, a camera, a remote controller signal receiver and the like. Additionally, the input unit 140 may also be implemented as a touch screen in the way that the input unit is included in a display. In particular, the microphone may receive a voice signal and convert the received voice signal into an electric signal.

The microphone may obtain a signal of a sound or a voice occurring outside the electronic apparatus 100. For example, the microphone may obtain vibrations according to a sound or a voice occurring outside the electronic apparatus 100, and convert the obtained vibrations into an electronic signal.

In particular, the microphone according to one or more embodiments may obtain a voice signal of a voice of the user, having occurred based on utterance of the user. Additionally, the obtained signal may be converted into a signal in a digital form, and stored in the memory 110. The microphone may include an analog to digital converter (A/D converter), and operate in association with an A/D converter placed outside the microphone.

According to one or more embodiments, the processor 120 may receive a user input through the microphone. For example, the processor 120 may receive a user voice selecting a type of an object in a voice signal form through the microphone. Additionally, the processor 120 may identify the type of the object corresponding to the user voice by using a trained voice recognition model and a natural language understanding model.

The camera may obtain an image of at least one object. For example, the camera may include an image sensor, and the image sensor may convert light coming in through a lens into an electric image signal.

According to one or more embodiments, the processor 120 may obtain a first image through the camera, and may also obtain sample data such as a plurality of third images, a plurality of fourth images and the like.

The output unit 150 may include circuitry, and the processor 120 may output various functions that may be performed by the electronic apparatus 100 through the output unit 150. Additionally, the output unit 150 may include at least one of a display, a speaker and an indicator.

The display may output image data under the control of the processor 120. For example, the display may output an image stored previously in the memory 110 under the control of the processor 120. In particular, the display according to one or more embodiments may also display a user interface stored in the memory 110. The display may be implemented as a liquid crystal display (LCD) panel, an organic light emitting diode (OLED) and the like, and additionally may also be implemented as a flexible display, a transparent display and the like in some cases. However, the display is not limited to a specific type of display.

The speaker may output audio data under the control of the processor 120.

The indicator may light up under the control of the processor 120. For example, the indicator may light up in various colors under the control of the processor 120. For example, the indicator may be implemented as a light emitting diode (LED), a liquid crystal display (LCD) panel, a vacuum fluorescent display (VFD) and the like, but not limited thereto.

According to one or more embodiments, the processor 120 may control the display to display the user interface, may covert information on a first type and information on a second type into a voice signal form, and may output the information on the first type and the information on the second type through the speaker. For example, the processor 120 may convert the information on the first type and the information on the second type into a voice signal form by using the trained voice synthesis model.

Operations in relation to artificial intelligence according to one or more embodiments are performed through the processor 120 and the memory 110 of the electronic apparatus 100.

The processor 120 may be comprised of one or a plurality of processors 120. At this time, the one or plurality of processors 120 may include at least one of a central processing unit (CPU), a graphic processing unit (GPU), and a neural processing unit (NPU), but not be limited thereto.

The CPU, as a general purpose processor 120 capable of performing an AI computation as well as a normal computation, may more efficiently execute a complex program through a multi-level cache structure. The CPU is advantageous in a series processing method enabling an organic connection between previous calculation results and following calculation results through a consecutive calculation. The general purpose processor 120 is not limited to the above-described examples, unless explicitly indicated as the above-described CPU.

The GPU as a processor 120 for a massive computation such as a floating-point computation and the like used to process graphics may perform a massive computation in parallel by integrating core in relatively large amounts. In particular, the GPU may be more advantageous in a parallel processing method such as a convolution computation and the like than the CPU. Additionally, the GPU may be used as a co-processor 120 for complementing a function of the CPU. A processor 120 for a massive computation is not limited to the above-described examples, unless explicitly indicated as the above-described GPU.

The NPU as a processor 120 specializing in an AI computation using an artificial neural network may be implemented in the way that each layer constituting an artificial neural network as hardware (e.g., silicon). Since the NPU is configured according to specifications required by a business, a freedom degree of the NPU is less than that of the CPU or the GPU, but may process an AI computation required by a business more efficiently. As a processor 120 specializing in an AI computation, the NPU may be implemented in various forms such as a tensor processing unit (TPU), an intelligence processing unit (IPU), a vision processing unit (VPU) and the like. An artificial intelligence processor 120 is not limited to the above examples, unless explicitly indicated as the above-described NPU.

Additionally, the one or plurality of processors 120 may be implemented as a system on a chip (SoC). In addition to the one or plurality of processors 120, memory 110, and a network interface such as a bus and the like for data communication between the processor 120 and the memory 110 may be further included in the SoC.

In the case where a plurality of processors 120 is included in a system on a chip (SoC) included in an electronic apparatus 100, the electronic apparatus 100 may perform an artificial intelligence-relating computation (e.g., a computation in relating to learning or inference of an artificial intelligence model) by using part 120 of the plurality of processors 120. For example, the electronic apparatus 100 may perform an AI-relating computation by using at least one of a GPU, an NPU, a VPU, a TPU, and a hardware accelerator specializing in an AI computation such as a convolution computation, a matrix multiplication computation and the like, among the plurality of processors 120. However, this is provided only as an example, and certainly, an AI-relating computation may be processed by using the CPU and the like and a general purpose processor 120.

Additionally, the electronic apparatus 100 may perform a computation in relation to an AI-relating function by using a multi core (e.g., a dual core, a quad core and the like) included in one processor 120. For example, the electronic apparatus 100 may perform an AI computation in parallel such as a convolution computation, a matrix multiplication computation and the like by using a multi core included in the processor 120.

The one or plurality of processors 120 may control to process input data, according to a predefined operation rule or an artificial intelligence model that is stored in the memory 110. The predefined operation rule or the artificial intelligence model is characterized in that the predefined operation rule or the artificial intelligence model is made through learning.

Herein, making the predefined operation rule or the artificial intelligence model through learning may be making a predefined operation rule or an artificial intelligence model of a desired feature, by applying a learning algorithm to large number of learning data. Such learning may be performed in an apparatus itself in which artificial intelligence according to the disclosure is performed, or performed through a separate server/system.

The artificial intelligence model may be comprised of a plurality of neural network layers. At least one layer has at least one weight value, and a computation of layer is performed through results of a computation of a previous layer and at least one defined computation. Examples of the neural network may include a convolutional neural network (CNN), a deep neural network (DNN), a recurrent neural network (RNN), a restricted boltzmann machine (RBM), a deep belief network (DBN), a bidirectional recurrent deep neural network (BRDNN), and a deep Q-network, and a transformer, but the neural network in the disclosure is not limited to the above example, unless explicitly stated otherwise.

The learning algorithm is a method that trains a predetermined object device (e.g., a robot) by using large number of learning data, enabling the predetermined object device to make decision or prediction. Examples of the learning algorithm may include supervised learning, unsupervised learning, semi-supervised learning or reinforcement learning, but the learning algorithm are not limited thereto.

A machine-readable storage medium may be provided in the form of a non-transitory storage medium. Herein, the term non-transitory indicates that the storage medium includes no signal (e.g., electromagnetic waves) and is tangible, while the term does distinguish semi-permanent or temporary storage of data in the storage medium. For example, the non-transitory storage medium may include a buffer in which data are temporarily stored.

According to various embodiments, the method set forth herein may be provided in a computer program product. The computer program product may be exchanged between a seller and a purchaser as a commodity. The computer program product may be distributed in the form of a machine-readable storage medium (e.g., compact disc read only memory (CD-ROM)) or distributed (e.g., downloaded or uploaded) online through an application store or directly between two user devices (e.g., smartphones). In the case of online distribution, at least part of the computer program product (e.g., a downloadable app) may be stored at least temporarily, or generated temporarily in a machine-readable storage medium such as a server of a manufacturer, a server of an application store, or memory 110 of a relay server.

Each of the elements (e.g., a module or a program) according to the various embodiments described above may be comprised of a single entity or a plurality of entities, and some of the corresponding sub elements described above may be omitted, or another sub element may be further included in the embodiments. Alternatively or additionally, some elements (e.g., modules or programs) may be integrated into one entity to perform identical or similar functions performed by each corresponding element prior to the integration.

Operations performed by a module, a program, or another element, according to the various embodiments, may be executed sequentially, in parallel, repetitively, or heuristically, or at least part of the operations may be executed in a different order, may be omitted, or may add a different operation.

The term unit or module set forth herein may include a unit comprised of hardware, software or firmware, and for example, may be used interchangeably with a logic, a logical block, a component, or a circuit and the like. The term unit or module may be an integrally constituted component, or a minimum unit or a part thereof performing one or more functions. For example, a module may be comprised of an application-specific integrated circuit (ASIC).

The various embodiments set forth herein may be implemented with software including instructions stored in a storage medium readable by a machine (e.g., a computer). The machine, as a device capable of calling the stored instructions from the storage medium and operating according to the called instructions, may include the electronic apparatus (e.g., an electronic apparatus 100) according to one or more embodiments.

Based on the instructions executed by a processor 120, the processor 120 may perform operations corresponding to the instructions directly or by using other elements under the control of the processor 120. The instructions may include a code generated or executed by a compiler or an interpreter.

While embodiments have been described with reference to the figures, it will be understood by those of ordinary skill in the art that various changes in form and details may be made therein without departing from the spirit and scope as defined by the following claims and their equivalents.

What is claimed is:

1. An electronic apparatus comprising:
memory configured to store at least one instruction; and
a processor configured to execute the at least one instruction to:
obtain a first image comprising an object;
input the first image to a first neural network model that is configured to be trained by using a plurality of second images in relation to a plurality of predefined types;
obtain first probability information comprising a first probability of the object corresponding to a first type among the plurality of types and a second probability of the object corresponding to a second type among the plurality of types;
obtain second probability information, through a second neural network model, indicating a type of the object included in the first image, by using a plurality of third images corresponding to the first type and a plurality of fourth images corresponding to the second type based on a difference between the first probability and the second probability being less than a first threshold value and based on a first input; and
identify the type of the object based on the second probability information.

2. The electronic apparatus as claimed in claim 1, wherein the second neural network model is configured to be trained based on a plurality of fifth images different from the plurality of second images, and obtain the second probability information based on a first similarity between the first image and the plurality of third images and a second similarity between the first image and the plurality of fourth images.

3. The electronic apparatus as claimed in claim 1 further comprising:
a display,
wherein the first type is a type that is identified through the first neural network model as a type among the plurality of types corresponding to the highest first probability,
wherein the second type is a type that is identified through the first neural network model as a type among the plurality of types corresponding to the second highest first probability, and
wherein the processor is further configured to identify the first type as the type of the object based on the difference between the first probability and the second probability being equal to or greater than the first threshold value and the first probability being equal to or greater than a second threshold value.

4. The electronic apparatus as claimed in claim 3, wherein the processor is further configured to:
control the display to display a user interface comprising information on the first type and information on the second type based on the difference between the first probability and the second probability being equal to or greater than the first threshold value and the first probability being less than the second threshold value;
receive a second user input selecting the type of the object through the user interface;
identify the first type as the type of the object based on the second user input corresponding to the first type;
obtain the second probability information through the second neural network model based on the second user input corresponding to the second type; and
identify the type of the object based on the second probability information.

5. The electronic apparatus as claimed in claim 4, wherein the second probability information comprises a third probability of the object corresponding to the first type and a fourth probability of the object corresponding to the second type, and
wherein the processor is further configured to:
identify the first type as the type of the object based on the third probability being greater than the fourth probability.

6. The electronic apparatus as claimed in claim 5, wherein the processor is further configured to:
control the display to display the user interface based on the third probability being less than the fourth probability;
receive a third user input, through the user interface, selecting the type of the object; and
identify the type of the object based on the third user input.

7. The electronic apparatus as claimed in claim 6, wherein the user interface comprises a first item corresponding to the first type, and a second item corresponding to the second type, and
wherein the processor is further configured to determine at least one of a size of the first item, a transparency of the first item, a size of the second item, and a transparency of the second item based on a size of the third probability and a size of the fourth probability.

8. The electronic apparatus as claimed in claim 6, wherein the memory is further configured to store the plurality of third images and the plurality of fourth images, and
wherein the processor is further configured to update the plurality of third images stored in the memory based on the first image based on the third user input corresponding to the first type.

9. The electronic apparatus as claimed in claim 8, wherein the memory is further configured to store information on fifth probabilities of each of the plurality of third images corresponding to the first type, and
wherein the processor is further configured to update the plurality of third images stored in the memory by replacing a third image corresponding to a probability with the first image and storing the first image in the memory based on the third probability being greater than one of the fifth probabilities.

10. The electronic apparatus as claimed in claim 6, wherein the processor is further configured to increase the first threshold value by a preset value based on the first probability being greater than the second probability, the third probability being less than the fourth probability, and the third user input corresponding to the second type.

11. A control method of an electronic apparatus, the method comprising:
obtaining a first image comprising an object;
inputting the first image to a first neural network model that is configured to be trained by using a plurality of second images in relation to a plurality of predefined types;
obtaining first probability information comprising a first probability of the object corresponding to a first type among the plurality of types and a second probability of the object corresponding to a second type among the plurality of types;
obtaining second probability information, through a second neural network model, indicating a type of the object included in the first image, by using a plurality of third images identified as corresponding to the first type and a plurality of fourth images identified as corresponding to the second type, based on a difference between the first probability and the second probability being less than a first threshold value and based on a first user input; and
identifying the type of the object based on the second probability information.

12. The method as claimed in claim 11, wherein the second neural network model is configured to be trained based on a plurality of fifth images different from the plurality of second images, and obtain the second probability information based on a first similarity between the first image and the plurality of third images and a second similarity between the first image and the plurality of fourth images.

13. The method as claimed in claim 11, wherein the first type is a type that is identified through the first neural network model as a type among the plurality of types corresponding to the highest first probability,
wherein the second type is a type that is identified through the first neural network model as a type among the plurality of types corresponding to the second highest first probability, and
wherein the method further comprises identifying the first type as the type of the object based on the difference between the first probability and the second probability being equal to or greater than the first threshold value and the first probability being equal to or greater than a second threshold value.

14. The method as claimed in claim 13, the method further comprising:
displaying a user interface comprising information on the first type and information on the second type based on the difference between the first probability and the second probability being equal to or greater than the first threshold value and the first probability being less than the second threshold value;
receiving a second user input, through the user interface, selecting the type of the object;
identifying the first type as the type of the object based on the second user input corresponding to the first type;
obtaining the second probability information through the second neural network model based on the second user input corresponding to the second type; and
identifying the type of the object based on the second probability information.

15. The method as claimed in claim 14, wherein the second probability information comprises a third probability of the object corresponding to the first type and a fourth probability of the object corresponding to the second type, and
wherein the method further comprises identifying the first type as the type of the object based on the third probability being greater than the fourth probability.

16. The method as claimed in claim 15, further comprising:
displaying the user interface based on the third probability being less than the fourth probability;
receiving a third user input, through the user interface, selecting the type of the object; and
identifying the type of the object based on the third user input.

17. The method as claimed in claim 16, wherein the user interface comprises a first item corresponding to the first type, and a second item corresponding to the second type, and
wherein the method further comprises determining at least one of a size of the first item, a transparency of the first item, a size of the second item, and a transparency of the second item based on a size of the third probability and a size of the fourth probability.

18. The method as claimed in claim 16, further comprising:
storing the plurality of third images and the plurality of fourth images; and
updating the plurality of third images stored in the memory based on the first image based on the third user input corresponding to the first type.

19. The method as claimed in claim 18, further comprising:
storing information on fifth probabilities of each of the plurality of third images corresponding to the first type; and
updating the plurality of third images stored in the memory by replacing a third image corresponding to a probability with the first image and storing the first image in the memory based on the third probability being greater than one of the fifth probabilities.

20. The method as claimed in claim 16, further comprising:
increasing the first threshold value by a preset value based on the first probability being greater than the second probability, the third probability being less than the fourth probability, and the third user input corresponding to the second type.
